(19) United States
(12) Patent Application Publication
(10) Pub. No.: US 2004/0228957 A1
(43) Pub. Date: Nov. 18, 2004

(54) Protein enhanced low carbohydrate snack food

(76) Inventor: James Carl Schmidt, Grosse Pointe Park, MI (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/839,330

(22) Filed: May 4, 2004

Related U.S. Application Data
(60) Provisional application No. 60/470,277, filed on May 14, 2003.
(60) Provisional application No. 60/503,055, filed on Sep. 15, 2003.

(51) Int. Cl. A23D 7/00

(52) U.S. Cl. 426/633

(57) ABSTRACT

A protein enhanced, low carbohydrate cream is described, wherein the cream includes up to about 50% by weight at least one sugar substitute, up to about 40% by weight protein material, and up to about 45% by weight fat material.

The present application claims priority under 35 U.S.C. § 119(e) from the following previously-filed Provisional Patent Applications: U.S. application Ser. No. 60/470,277, filed May 14, 2003, entitled “Protein Enhanced Low Carbohydrate Foods”; and U.S. application Ser. No. 60/503,055, filed Sep. 15, 2003, entitled “Protein-Enhanced Low-Carbohydrate Cream for Filling, Icing, and Other Food Applications,” both filed by James C. Schmidt, and which are incorporated herein by reference in their entirety.

### BACKGROUND

The current candy and confection industry is based upon refined sugar, high-fructose corn syrups and other sweeteners that cause excessive elevation of blood sugar when eaten. The excessive blood sugar not used by the body is converted to fat as an energy source for later use. High blood sugar resulting from eating sugar-carbohydrate rich candies and confections is believed to promote obesity and diabetes.

There has been a trend lately to use foods low in carbohydrates, especially those high in protein, as part of a diet advocated for many years by diet guru Robert Atkins, M.D., and often called the Atkins diet. After decades of medical ridicule, the Atkins diet recently gained some credibility with the release of widely publicized research from Duke University. Dieters in the Atkins-funded study lost an average of 20 pounds in six months, and also saw improvements in cholesterol and other cardiovascular risk factors.

Low carbohydrate diets, such as the Atkins diet, cause the body to burn fat and muscle tissue to obtain needed energy because there are no carbohydrates to supply the energy. To prevent losses of muscle tissue a dieter should consume greater amounts of protein, since protein supplies energy and builds and repairs muscle tissue.

Cream fillings are common ingredients of many snack foods, such as confectionaries and pastries, and are typically used as fillings or icings in such. Cream fillings are usually high in carbohydrates, such as refined sugar. In the body these carbohydrates are broken down into glucose, thereby significantly increasing blood sugar levels as well as providing high amounts of calories. Snack foods that incorporate these cream fillings are not suitable for diabetics and low carbohydrate dieters.

Nevertheless, while some snack foods and cream fillings may be low in carbohydrates, they typically do not have a flavor that is favorable to a dieter's taste, and adding protein to such foods makes it even harder to maintain a desirable flavor. These foods either have a poor flavor, or contain little to no protein.

Conventional efforts to make a protein enhanced, low carbohydrate cream filling have also failed due to the difficulty in maintaining proteins in a stable suspension. It has been difficult to maintain proteins in a suspension because their natural density and inherent isoelectric pH cause them to resist suspension and/or to resist bonding in the presence of one or more different proteins. The proteins' isoelectric pH also cause them to repel each other rather than bond together. Thus, it has been difficult for an individual to use protein enhanced, low carbohydrate snack foods as part of a low carbohydrate diet, such as the Atkins diet. The result is that an individual is less likely to follow the diet and obtain the benefits therefrom.

### SUMMARY

A protein enhanced, low carbohydrate cream is described, wherein the cream includes up to about 50% by weight at least one sugar substitute, up to about 40% by weight protein material, and up to about 45% by weight fat material.

### BRIEF DESCRIPTION OF THE DRAWINGS

The products and processes described herein can be understood in light of FIGS. 1-3, in which:

FIG. 1 depicts one aspect of a method for making a protein enhanced, low carbohydrate cream filling;

FIG. 2 depicts one aspect of a method for making a protein enhanced, low carbohydrate cream filling; and

FIG. 3 depicts one aspect of a method for making a protein enhanced, low carbohydrate cream filling.

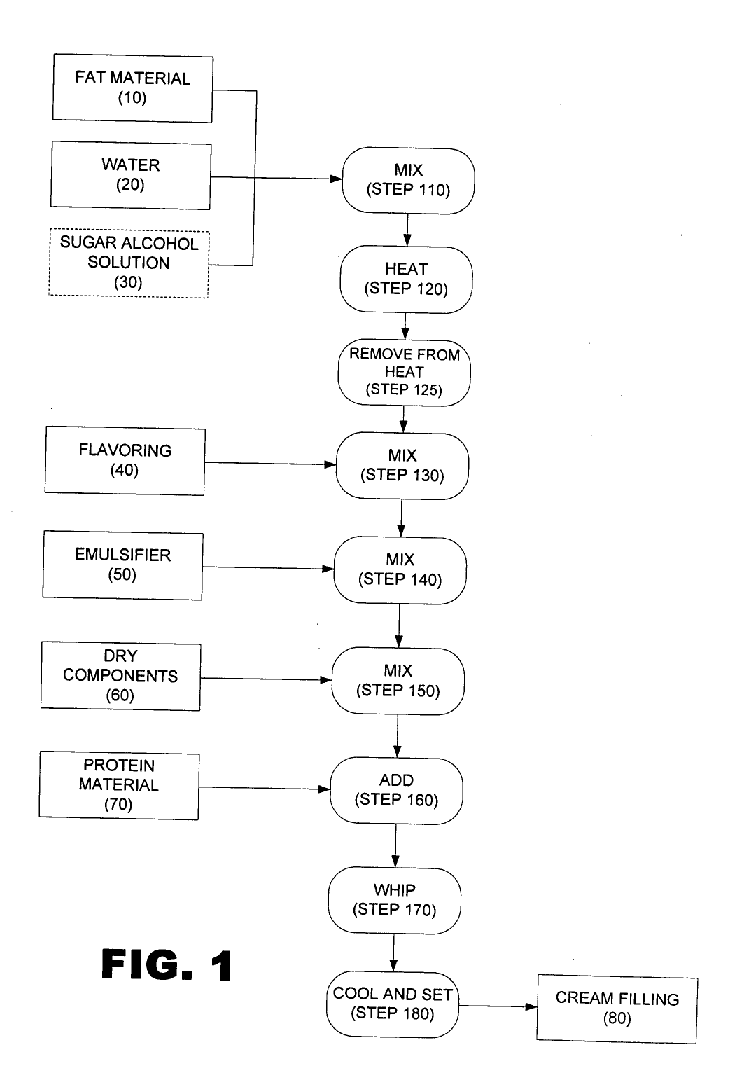

FIGS. 1-3 illustrate specific aspects of the products and processes described in the present specification and constitute a part of the specification. Together with the following description, the Figures demonstrate and explain the principles of the products and processes.

### DETAILED DESCRIPTION

The following description provides specific details in order to provide a thorough understanding of the novel cream filling and snack foods incorporating the cream filling. The skilled artisan will understand, however, that the products and methods described below can be practiced without employing these specific details. Indeed, they can be modified and can be used in conjunction with products and techniques conventionally used in the industry. The products and techniques could easily be adapted for use in foods other than snack foods, or could be altered to provide various nutritional benefits for a diet other than a high protein, low carbohydrate diet.

As used in the present specification and the appended claims, the term “total carbohydrate content” refers to the sum total of all carbohydrates in the food. “Net effective carbohydrates” refers generally to those carbohydrates that have a significant impact on increasing blood glucose levels. Finally, all concentrations referred to in the present specification and appended claims are given in terms of weight percent of the cream filling, unless otherwise noted.

The snack foods described in this specification contain a protein enhanced, low carbohydrate cream filling. The cream filling is made from a novel blend, formulation and technique of combining sugar substitutes, proteins, and other ingredients, thus resulting in a high protein, low carbohydrate cream filling that is suitable for diabetics and for use with a low carbohydrate diet. In addition, the cream filling may also contain vitamins, minerals, botanicals, and/or neutraceuticals to provide additional health benefits.

Sugar Substitute

The cream filling delivers a low carbohydrate content by using a sugar substitute, or a combination of sugar substitutes, in place of natural sugar. The sugar substitutes used in the cream filling may include nutritive sweeteners, such as sugar alcohols and carbohydrate fiber sweeteners, and/or non-nutritive sweeteners. Sugar substitutes do not significantly increase blood sugar levels and therefore do not count as net effective carbohydrates.

Sugar alcohols are well-suited for use as sugar substitutes in low carbohydrate foods. They provide fewer calories (about a half to one-third less calories) than regular sugar because they are converted to glucose more slowly; they require little or no insulin to be metabolized and do not cause sudden increases in blood sugar. Thus, sugar alcohols do not cause the detrimental effects on diabetics that other carbohydrates cause. Examples of sugar alcohols include, but are not limited to, mannitol, sorbitol, xylitol, lactitol, isomalt, maltitol, erythritol, and hydrogenated starch hydrolysates (HSH). The total amount of sugar alcohol can comprise up to about 50% of the cream filling.

The cream filling generally comprises crystalline maltitol or crystalline sorbitol as the primary sugar alcohol. Additionally, maltitol solution may be used to improve the texture, moisture content and crystallization properties of the mixture. The concentration of sorbitol can vary depending on the desired texture, consistency and sweetness of the cream filling, but typically ranges from about 8% to about 22%.

Other nutritive sweeteners that can also be used in the cream filling include carbohydrate fiber sweeteners such as inulin and oligofructose. In addition to providing sweetness to the cream filling, inulin and oligofructose also add bulk and creaminess, and are useful as fat replacements. Inulin and oligofructose are also good sources of soluble dietary fiber and are well-suited for diabetics because they do not increase the blood sugar level or insulin level due to their indigestible nature. The amount of inulin or oligofructose can vary according to the desired color, flavor and texture of the cream filling.

The cream filling may also include a combination of various nutritive sweeteners. In one embodiment maltitol comprises about 80% of the sugar alcohol in the cream filling. In another embodiment, the cream filling also contains mannitol. Mannitol is a white, crystalline sugar alcohol added to processed foods for the purpose of thickening, stabilizing and sweetening. It is approximately 72% as sweet as sucrose and has a cool, sweet taste. Using mannitol in combination with maltitol or other sugar alcohols also varies and improves the texture, flavor and sweetness of the cream filling. Thus, the amount of mannitol, and its ratio with other sugar alcohols, depends on the desired texture, flavor and sweetness of the cream filling. In one embodiment, mannitol comprises up to about 10% of the cream filling. In another embodiment, mannitol comprises about 20% of the total sugar substitutes used. In one particular embodiment, the weight ratio of powdered mannitol to crystalline maltitol is about 1:3.5.

Non-nutritive sweeteners can also be used in the cream filling as sugar substitutes or flavoring to reduce the net effective carbohydrate content of food while still providing a sweet taste. These non-nutritive sweeteners can be used in addition to, or in place of, sugar alcohols. These sweeteners can be hundreds of times sweeter than sucrose, yet they contain many fewer calories than sucrose. Non-nutritive sweeteners also have little to no effect on blood sugar levels. Non-nutritive sweeteners include, but are not limited to, aspartame, alitame, cyclamates, saccharin, acesulfame, sucralose, neohesperidin dihydrochalcone, stevia sweeteners, glycyrrhizin, thaumatin, and the like, and mixtures thereof. In one embodiment the cream filling comprises up to about 0.05% sucralose. In another embodiment sucralose comprises up to about 0.25% of the sorbitol added. Nevertheless, the concentration of the non-nutritive sweetener will depend upon its sweetness and the desired sweetness of the cream filling.

Protein Material

In addition to lowering the carbohydrate content, the cream filling also provides a high protein content. Protein helps prevent loss of muscle tissue, as well as provides small amounts of dietary fiber. Generally the cream filling can comprise up to about 38% total protein material. The protein material that can be used in the cream filling includes, but is not limited to, soy and soy isolates, whey and whey isolates, micro cross filtered whey isolates, wheat proteins (e.g., glutenir, gliadin, and gluten), isolated grain and vegetable based proteins, egg white protein, protein isolates, albumen isolates, legume based proteins, nuts, and peanut butter. Vegetable based proteins include any vegetable in which proteins may be collected, whether condensed, accumulated or isolated. Examples of protein-providing vegetables include spelt, quinoa, amaranth, buckwheat, black rice, and the like.

In one embodiment the cream filling contains whey protein. Whey protein is available in a number of different types based upon the protein content of the whey source, which can range from about 25% to about 90%. In one embodiment the cream filling comprises from about 6% to about 14% whey protein isolate. In another embodiment the cream filling comprises peanut butter in a concentration of up to about 32% of the cream filling. The protein content may also be increased by substituting a like volume of protein material for the bulking agent.

Fat Material

The cream filling can also contain fat material, which affects the richness, flavor, texture and stability of the cream filling, as well as hardness and melting properties. The fat material of the cream filling can include vegetable fats and oils such as cocoa butter, cream butter, canola oil, illippe butter, sal oil, shea butter, margarine, vegetable shortening, palm oil, palm nuclei oil, cottonseed oil, sunflower seed oil, peanut oil, rice bran oil, corn oil, safflower oil, olive oil, kapok oil, sesame oil, and evening primrose oil, and animal fats and oils such as cream, tallow, lard, fish oil, and whale oil. The fat material can comprise up to about 50% of the cream filling. In one embodiment the cream filling comprises from about 26% to about 44% cocoa butter.

Bulking Agent

The cream filling may also comprise a bulking agent to add thickness and bulk to the cream filling. Many compounds are useful as bulking agents, such as sugar alcohols, protein isolates, starches, inulin, oligofructose, polydextrose, maltodextrin, and fibers, such as bamboo fiber, wheat fiber, oat fiber, and other plant-based fibers. The concentration of the bulking agent generally comprises up to about 30% of the cream. In one embodiment the cream filling comprises up to about 30% polydextrose. In another embodiment, the cream filling comprises between about 21% and about 29% polydextrose. When non-nutritive sweeteners are used in the cream filling in place of nutritive sweeteners, more bulking agent may be needed to increase bulk. Other components can also be used to provide bulk, such as sugar alcohols, carbohydrate fiber sweeteners, and protein material. For example, polydextrose may be eliminated by substituting a like volume of protein isolates.

Other Components

The cream filling may also contain an emulsifier to aid in dispersing the fat material. In one embodiment the emulsifier is lecithin, which is found in egg yolks and legumes, such as soy. In a particular embodiment of the cream filling the emulsifier is soy lecithin. Generally the concentration of the emulsifier does not exceed 1%.

The cream filling can also contain water and/or flavoring. Water increases the moisture content, and hence can alter the cream filling texture. It also aids in providing a medium in which the components mix and interact with each other. The amount of water added depends on the desired consistency, texture and moisture content. In one embodiment water comprises about 11% of the cream filling.

The flavoring that can be used in the cream filling can include anything to produce a desirable taste, such as vanilla, chocolate, cocoa, mint, peppermint, cinnamon, fruit, fruit extracts and essences, nuts and nut extracts, chili pepper, caramel, peanut butter, sarsaparilla, sassafras, wild cherry, wintergreen, ginger, nutmeg, honey, malt, grain flavors, paprika, garlic, salt and others well known to those of skill in the art. The amount of flavoring added can vary according to the desired taste. In one embodiment the cream filling includes vanilla in a concentration of less than about 1%. In another embodiment the cream filling contains up to about 0.2% peppermint oil. In another embodiment the cream filling contains up to about 32% peanut butter, and up to about 6% peanut extract. In another embodiment, the cream filling contains up to about 10% cocoa powder. The cream filling may also contain chocolate liquor to help stabilize the mixture and improve texture and consistency. The amount of salt also varies according to taste, and in one aspect it comprises less than 1%.

Additional Nutrients

The cream filling can also contain vitamins and minerals. Examples of vitamins that can be added to the cream filling include, but are not limited to, vitamin A, vitamin B₁, vitamin B₂ (riboflavin), vitamin B₆, vitamin B₁₂, vitamin C, vitamin D, vitamin E, vitamin K, para-aminobenzoic acid, niacin, inositol, biotin, folic acid, and choline. Examples of minerals that can be added include, but are not limited to, magnesium, iron, zinc, copper, manganese, sodium, potassium, calcium, selenium, chromium, molybdenum, chlorine, fluorine, phosphorus, sulfur, and iodine.

The cream filling can also contain botanicals or neutraceuticals such as, but not limited to, bilberry, cascara, cat's claw, cayenne, cranberry, devil's claw, dong quai, echinacea, evening primrose oil, feverfew, garlic, ginger, ginkgo, Asian ginseng, Siberian ginseng, goldenseal, gotu kola, grape seed, green tea, hawthorn, kava, licorice, milk thistle, noni, saw palmetto, St. John's wort, valerian, melatonin, damiana, yerbe mate, guarana, and the like.

Methods for Making

The cream filling can be made in a number of methods by adding various ingredients, including fat material, protein material and/or sugar substitutes. The cream filling may then be formed into various shapes and/or used in the manufacturing of snack foods. Generally, the cream is made by adding sugar alcohol(s) after adding fat material, and adding protein material after the addition of the sugar alcohol(s). Other ingredients can be added to the cream mixture before and/or after addition of sugar alcohols and/or protein material. In one aspect the protein material is added to the cream last. In another aspect, fiber material, such as inulin, is added with the protein material to provide texture and thickening. In another aspect, lecithin is added to the fat material before the fat material is combined with dry sugar alcohols to prevent the formation of lumps.

The cream may be made according to a warm method in which the fat material is liquid. In an aspect, the fat material can be made liquid by combining it with water and heating until the fat material melts, such as by boiling. In another aspect, the fat material can be made liquid by melting it over heat. When using the warm method, lecithin and flavoring, such as vanilla, are added off heat so as to not drive or flash the flavoring out of the solution. Creams made according to the warm method have a better flow rate and are more fluid for pumping and flooding wafer sheets, molds, and other dies. In one aspect, after combining all ingredients, creams made according to the warm method are allowed to set into a solid by cooling. In another aspect, the cream can also be made according to a cold method, in which the fat material is not melted. In this aspect, the fat material can be whipped or creamed. Creams made according to the cold method are not as fluid as creams made by the warm method.

In the following description of the figures, any repetition of reference numbers is incidental and does not necessarily represent identical components throughout the figures. Also, any reference to the term “mix” does not necessarily mean solely the act of mixing, but rather it also means adding to and/or combining.

One exemplary method of making a high protein, low carbohydrate cream filling is shown in FIG. 1. First, fat material (10) and water (20) are combined and mixed (step 110). A liquid sugar alcohol solution (30) may also be combined and mixed with the fat and water. This mixture can then be heated (step 120) until the fat material (10) becomes liquid. After removing from heat (step 125), flavoring (40) is mixed in (step 130), after which an emulsifier (50) is then added and mixed in (step 140). Dry components (60) are then mixed and combined with the mixture (step 150). The dry components (60) usually include crystalline and/or powdered sugar alcohols, but may also include salt. Finally, protein material (70) is added to the mixture (step 160), after which the mixture is then whipped (step 170). The mixture can then be allowed to cool and set to the desired consistency (step 180), resulting in a high protein, low carbohydrate cream filling (80).

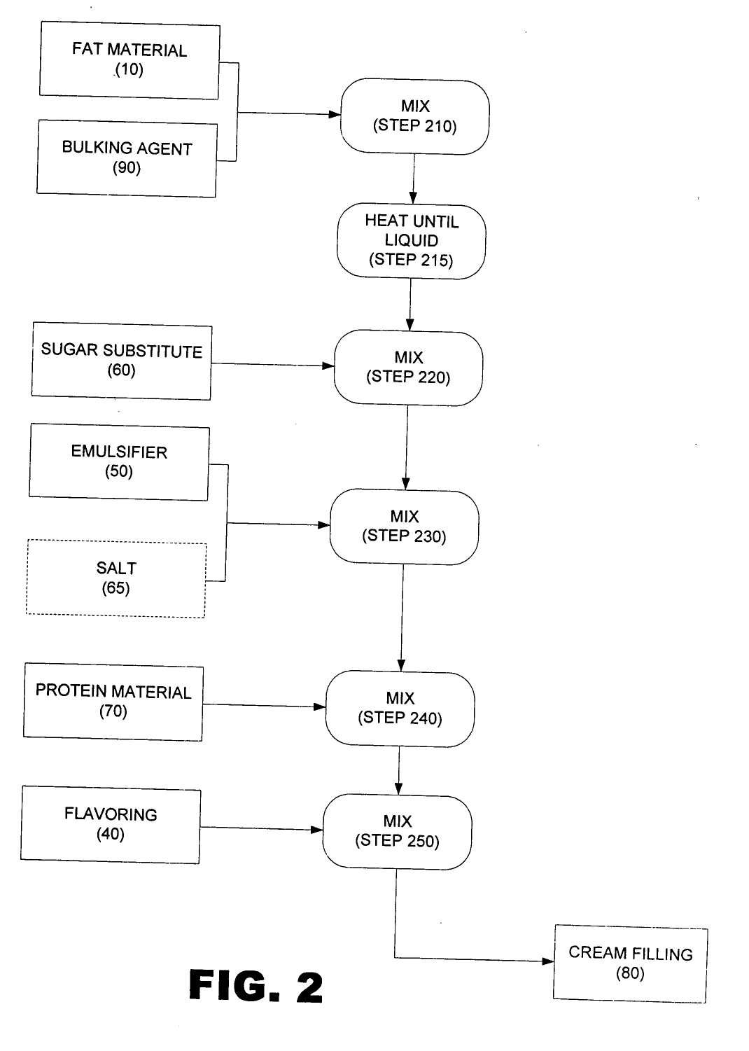

In another exemplary method of making a cream filling, as shown in FIG. 2, a bulking agent (90) is first combined and mixed (step 210) with a fat material (10) in a mixer. This mixture is then heated (step 215) until the fat material (10) becomes liquid. A sugar substitute (60), typically a sugar alcohol, is then added and mixed with the mixture (step 220). An emulsifier (50) is then added and mixed into the mixture (step 230); salt (65) may also be added and mixed in. Protein material (70) is then added to the mixture and mixed in (step 240). Finally, flavoring (40) and non-nutritive sweeteners, such as sucralose, are added and mixed in (step 250), resulting in a high protein, low carbohydrate cream filling (80). In one aspect this process is carried out at higher temperatures in order to produce a fluid cream filling (80) having a better flow rate. Cream fillings having better flow rates allow for easier pumping and flooding of wafer sheets and other confectionary dies, casts, molds, and forms. The heated cream filling (80) may then be solidified by cooling.

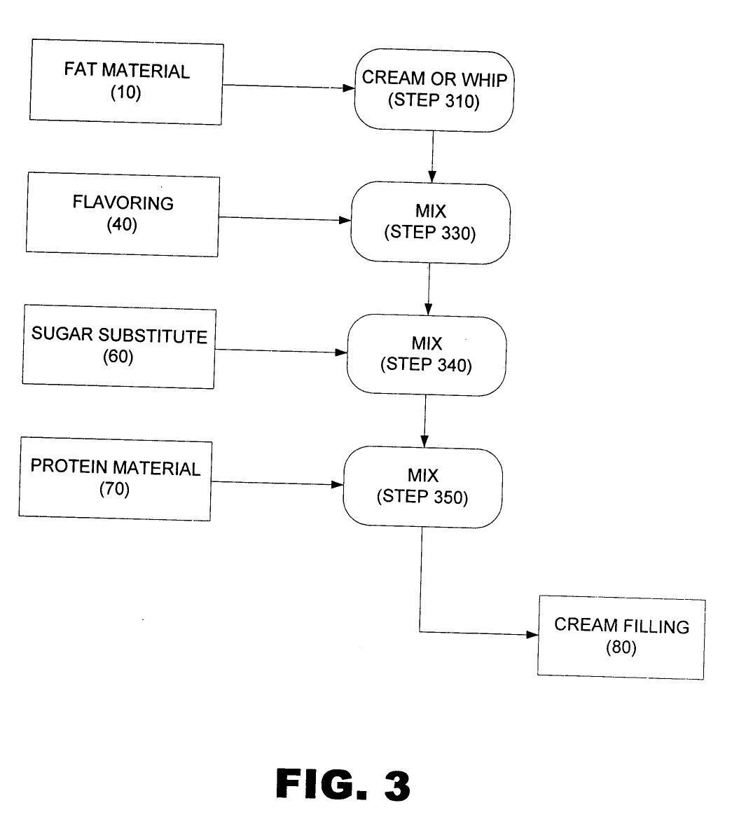

In another exemplary method of making a cream filling, as shown in FIG. 3, the following steps are followed. First, fat material (10) is creamed or whipped (step 310). In one embodiment the fat material (10) comprises butter, such as dairy butter. Flavoring (40), such as vanilla and/or caramel flavor, is then added and mixed into the mixture (step 330). In one aspect caramel is added to the creamed fat material. The caramel may be any type of caramel, such as sugar-free or regular. A sugar substitute (60), typically a fine crystalline or powdered sugar alcohol, is then added and mixed into the mixture (step 340). In one embodiment, the sugar substitute (60) is a fine crystalline sorbitol, such as Sorbogem™ (manufactured by SPI Polyols, Inc.). In another embodiment, the sugar substitute (60) is a fine maltitol. Finally, protein material (70) is added to the mixture and mixed in (350), resulting in a high protein, low carbohydrate cream filling (80).

Once the cream filling has been made, it can be shaped, molded, or formed into any desired shaped, and can be incorporated into any desired snack, confection, pastry or other food. In one embodiment the cream filling is used as a filling in wafers, cookies, sandwich-type cookies, confections, pastries, breakfast-pastries, cakes, donuts, bagels, desserts, pies, waffles, and the like. In another embodiment the cream filling is used as a coating or icing for the above-listed foods. Indeed, the cream filling may be used anywhere a sugar or sugar-free cream filling or icing may be used.

### EXAMPLES

The cream filling can be better understood with a description of the following examples. It should be understood that the following are only examples and should not be used to limit the cream filling to the methods and compositions described below.

### EXAMPLE 1

A protein enhanced, low carbohydrate cream filling was prepared from the ingredients and compositions listed in Table 1a.

TABLE 1a

| Ingredient | Weight % of Cream |
|---|---|
| Cocoa Butter | 29.3 |
| Water | 10.7 |
| Maltisweet ™ 3145 | 4.9 |
| Vanilla | <1 |
| Soy Lecithin | 1.0 |
| Crystalline Maltitol | 34.1 |
| Powdered Mannitol | 9.8 |
| Salt | <1 |
| Whey Protein Isolate | 9.8 |

First, the cocoa butter, water, and Maltisweet™ 3145 were mixed together and heated to a boil. Once this liquid mixture reached a boil, it was removed from heat. Vanilla and soy lecithin were then added, causing the mixture to foam over. After the mixture foamed over it was added and combined with a dry mixture containing crystalline maltitol, powdered mannitol, and salt. Whey proteins were then added last, after which the combined mixture was then whipped in a mixer. The cream filling was then allowed to cool and set to the desired consistency. The resulting cream filling has the properties listed in Table 1b.

TABLE 1b

| | Weight (g) per 28 g |
|---|---|
| | Cream Filling Serving |
| Protein | 3 |
| Total Carbohydrates | 14 |
| Sugar Alcohol | 14 |
| Net Effective Carbohydrates | <1 |

### EXAMPLE 2

A protein enhanced, low carbohydrate cream filling was made from the ingredients and compositions listed in Table 2a.

TABLE 2a

| | Weight % of Cream |
|---|---|
| Ingredient | Filling |
| Lecithin | <1 |
| Salt | <1 |
| Cocoa Butter | 43.2 |
| Crystalline Sorbitol | 21.1 |
| Polydextrose | 28.7 |
| Whey Protein Isolate | 6.0 |
| Sucralose | <1 |
| Vanilla Extract (two fold) | <1 |

The cream was made by first combining and mixing polydextrose with cocoa butter in a turbo mixer. The mixture was then heated until the cocoa butter became liquid. Crystalline sorbitol was then added to the mixture and mixed in. Next, lecithin and salt were added and mixed in, after which whey protein isolate was added and mixed in. Finally, sucralose and vanilla extract were added and mixed in last. The resulting cream filling has the properties listed in Table 2b.

TABLE 2b

| | Weight (g) per 28 g |
|---|---|
| | Cream Filling Serving |
| Protein | 2 |
| Total Carbohydrates | 14 |
| Sugar Alcohol | 6 |
| Fiber | 8 |
| Net Effective Carbohydrates | <1 |

### EXAMPLE 3

A protein enhanced, low carbohydrate cream filling was prepared from the ingredients and compositions listed in Table 3a.

TABLE 3a

| | Weight % of Cream |
|---|---|
| Ingredient | Filling |
| Lecithin | <1 |
| Salt | <1 |
| Cocoa Butter | 43.4 |
| Crystalline Sorbitol | 21.2 |
| Polydextrose | 28.8 |
| Whey Protein Isolate | 6.0 |
| Sucralose | <1 |
| Peppermint Oil | <1 |

The cream filling was prepared according to the method and sequence of Example 2, except that peppermint oil was added instead of vanilla extract. The resulting cream filling has the properties listed in Table 3b.

TABLE 3b

| | Weight (g) per 28 g |
|---|---|
| | Cream Filling Serving |
| Protein | 2 |
| Total Carbohydrates | 14 |
| Sugar Alcohol | 6 |
| Fiber | 8 |
| Net Effective Carbohydrates | <1 |

### EXAMPLE 4

A protein enhanced, low carbohydrate cream filling was prepared from the ingredients and compositions listed in Table 4a.

TABLE 4a

| | Weight % of Cream |
|---|---|
| Ingredient | Filling |
| Peanut Butter | 32.1 |
| Peanut Extract | 5.7 |
| Salt | <1 |
| Cocoa Butter | 26.4 |
| Crystalline Sorbitol | 8.5 |
| Polydextrose | 21.3 |
| Whey Protein Isolate | 5.7 |
| Sucralose | <1 |

The cream filling was prepared by first combining cocoa butter and polydextrose in a turbo mixer and mixing. The mixture was then heated until the cocoa butter became liquid. Peanut butter was then added and mixed in, after which crystalline sorbitol was added and mixed in. Lecithin and salt were then added, after which whey protein isolate was added and mixed in. Finally, sucralose and peanut extract were added and mixed in. The resulting cream filling has the properties listed in Table 4b.

TABLE 4b

| | Weight (g) per 28 g |
|---|---|
| | Cream Filling Serving |
| Protein | 4 |
| Total Carbohydrates | 8 |
| Sugar Alcohol | 2 |
| Fiber | 6 |
| Net Effective Carbohydrates | <1 |

### EXAMPLE 5

A protein enhanced, low carbohydrate cream filling was prepared from the ingredients and compositions listed in Table 1a.

TABLE 5a

| | Weight % of Cream |
|---|---|
| Ingredient | Filling |
| Lecithin | <1 |
| Salt | <1 |
| Cocoa Butter | 40.6 |
| Crystalline Sorbitol | 16.8 |
| Polydextrose | 21.9 |
| Whey Protein Isolate | 9.2 |
| Sucralose | <1 |
| Cocoa Powder | 9.5 |
| Chocolate Liquor | 1.5 |

The cream filling was prepared according to the method and sequence of Example 2, except that cocoa powder and chocolate liquor were added instead of vanilla extract. The resulting cream filling has the properties listed in Table 5b.

TABLE 5b

| | Weight (g) per 28 g |
|---|---|
| | Cream Filling Serving |
| Protein | 3 |
| Total Carbohydrates | 11 |
| Sugar Alcohol | 5 |
| Fiber | 6 |
| Net Effective Carbohydrates | <1 |

### EXAMPLE 6

For comparison purposes, the nutritional composition of a protein enhanced, low carbohydrate cookie comprising the cream of Example 1 is shown in Table 6a, the nutritional composition of a traditional OREO® cookie comprising a sugar-based cream is shown in Table 6b, and that of a traditional SNACKWELL'S® cookie comprising sugar-free cream is shown in Table 6c.

TABLE 6a
Protein Enhanced, Low Carbohydrate Cookie

| | Weight (g) per 28 g |
|---|---|
| | Cookie Serving |
| Protein | 8-12 |
| Total Carbohydrates | 9 |
| Sugar Alcohol | 8 |
| Fiber | <1 |
| Net Effective Carbohydrates | <1 |

TABLE 6b
Traditional OREO ® Cookie

| | Weight (g) per 28 g |
|---|---|
| | Cookie Serving |
| Protein | 1 |
| Total Carbohydrates | 20 |
| Sugar Alcohol | 0 |
| Fiber | 1 |
| Net Effective Carbohydrates | 19 |

TABLE 6c
Traditional SNACKWELL'S ® Cookie

| | Weight (g) per 28 g |
|---|---|
| | Cookie Serving |
| Protein | 1 |
| Total Carbohydrates | 18 |
| Sugar Alcohol | 7 |
| Fiber | 1 |
| Net Effective Carbohydrates | 10 |

In addition to any previously indicated variation, numerous other modifications and alternative arrangements may be devised by those skilled in the art without departing from the spirit and scope of the principles described herein, and the appended claims are intended to cover such modifications and arrangements.

What is claimed is:

1. A high protein, low carbohydrate cream, comprising, by weight:
up to about 45% fat material;
up to about 50% sugar substitute; and
up to about 40% protein material.

2. The cream of claim 1, further comprising, by weight:
up to about 1% emulsifier; and
up to about 1% salt.

3. The cream of claim 1, further comprising a vitamin, mineral, neutraceutical, botanical, or combination thereof.

4. The cream of claim 1, further comprising inulin, oligofructose, or a combination thereof.

5. The cream of claim 1, further comprising, by weight: up to about 11% water.

6. The cream of claim 5, further comprising flavoring.

7. The cream of claim 5, wherein:
said fat material comprises about 29% of said cream by weight;
said sugar substitute comprises about 49% of said cream by weight; and
said protein material comprises about 10% of said cream by weight.

8. The cream of claim 7, wherein:
said fat material comprises cocoa butter;
said sugar substitute comprises crystalline maltitol; and
said protein material comprises whey protein isolate.

9. The cream of claim 8, wherein said sugar substitute further comprises: maltitol solution; and mannitol.

10. The cream of claim 9, wherein:
said crystalline maltitol comprises about 34% of said cream by weight;
said maltitol solution comprises about 5% of said cream by weight; and
said mannitol comprises about 10% of said cream by weight.

11. A high protein, low carbohydrate cream, comprising, by weight:
up to about 45% fat material;
up to about 25% sugar substitute;
up to about 40% protein material;
up to about 30% bulking agent; and
up to about 12% flavoring.

12. The cream of claim 11, wherein said fat material comprises from about 26% to about 44% of said cream by weight.

13. The cream of claim 12, wherein said fat material comprises from about 40% to about 44% of said cream by weight.

14. The cream of claim 11, wherein said sugar substitute comprises from about 8% to about 22% of said cream by weight.

15. The cream of claim 14, wherein said sugar substitute comprises from about 16% to about 22% of said cream by weight.

16. The cream of claim 11, wherein said protein material comprises from about 5% to about 38% of said cream by weight.

17. The cream of claim 16, wherein said protein material comprises from about 6% to about 10% of said cream by weight.

18. The cream of claim 11, wherein said bulking agent comprises from about 21% to about 29% of said cream by weight.

19. The cream of claim 11, wherein said flavoring comprises less than about 1% of said cream by weight.

20. The cream of claim 11, wherein said flavoring comprises from about 5% to about 12% of said cream by weight.

21. The cream of claim 11, wherein:
said fat material comprises cocoa butter;
said sugar substitute comprises sorbitol, sucralose, or a combination thereof;
said protein material comprises whey protein isolate, peanut butter, or a combination thereof; and
said bulking agent comprises polydextrose.

22. The cream of claim 11, wherein:
said fat material comprises about 43% by weight of said cream;
said sugar substitute comprises about 21% by weight of said cream;
said protein material comprises about 6% by weight of said cream;
said bulking agent comprises about 29% by weight of said cream; and
said flavoring comprises less than about 1% by weight of said cream.

23. The cream of claim 22, wherein said flavoring comprises vanilla extract.

24. The cream of claim 22, wherein said flavoring comprises peppermint oil.

25. The cream of claim 11, wherein:
said fat material comprises about 26% by weight of said cream;
said sugar substitute comprises about 8% by weight of said cream;
said protein material comprises about 38% by weight of said cream;
said bulking agent comprises about 21% by weight of said cream; and
said flavoring comprises about 6% by weight of said cream.

26. The cream of claim 25, wherein said flavoring comprises peanut extract.

27. The cream of claim 25, wherein said protein material comprises:
peanut butter; and
whey protein;
wherein said peanut butter comprises up to about 32% by weight of said cream, and said
whey protein comprises up to about 6% by weight of said cream.

28. The cream of claim 11, wherein:
said fat material comprises about 40% by weight of said cream;
said sugar substitute comprises about 17% by weight of said cream;
said protein material comprises 9% by weight of said cream;
said bulking agent comprises about 21% by weight of said cream; and
said flavoring comprises about 11% by weight of said cream.

29. The cream of claim 28, wherein said flavoring comprises:
cocoa powder and chocolate liquor; wherein
said cocoa powder comprises about 10% by weight of said cream; and
said chocolate liquor comprises about 2% by weight of said cream.

30. A high protein, low carbohydrate cream, comprising, by weight:
up to about 50% protein; and
less than about 4% net effective carbohydrates.

31. A method for making a protein enhanced, low carbohydrate cream, comprising:
forming a mixture of fat material, at least one sugar alcohol, and protein material;
wherein said sugar alcohol is added to said mixture after adding said fat material, and
said protein material is added to said mixture after adding said sugar alcohol.

32. The method of claim 31, wherein said fat material is made liquid before adding said sugar alcohol.

33. The method of claim 31, wherein said fat material is creamed or whipped before adding said sugar alcohol.

34. The method of claim 31, further comprising adding fiber material.

35. The method of claim 31, further comprising adding flavoring and an emulsifier.

36. The method of claim 35, wherein said protein material is added last.

37. The method of claim 35, wherein said emulsifier is added after adding said fat material and before adding said sugar alcohol.

38. A method for making a protein enhanced, low carbohydrate cream, comprising:
combining fat material, water, and a sugar alcohol solution;
heating;
adding flavoring;
adding an emulsifier;
adding a dry mixture having at least one dry sugar alcohol;
adding protein material; and
whipping.

39. The method of claim 38, wherein said dry mixture comprises crystalline maltitol, powdered mannitol, salt, or a combination thereof.

40. The method of claim 38, further comprising cooling the mixture.

41. The method of claim 38, wherein said heating occurs until said fat material becomes liquid.

42. A method for making a protein enhanced, low carbohydrate cream, comprising:
forming a mixture of fat material and a bulking agent;
heating the mixture;
adding a sugar substitute;
adding an emulsifier;
adding protein material;
adding flavoring.

43. The method of claim 42, wherein said heating occurs until said fat material becomes liquid.

44. A method for making a protein enhanced, low carbohydrate cream, comprising:
creaming or whipping fat material;
adding an emulsifier;
adding flavoring;
adding a sugar substitute; and
adding protein material.

45. A snack food, comprising a high protein, low carbohydrate cream.

46. The snack food of claim 45, wherein said snack food is one of a wafer cookie, filled layered cookie, filled donut, pastry, or strudel.

47. The snack food of claim 45, wherein said cream is used as a cream filling.

48. The snack food of claim 45, wherein said cream is used as a cream icing.

49. A nutritional supplement, comprising a snack food containing a high protein, low carbohydrate cream.

50. A diet, comprising a snack food, wherein said snack food contains a high protein, low carbohydrate cream.

51. A method of losing weight and increasing health, comprising:
providing a diet that is low in carbohydrates and high in protein;
wherein said diet includes a snack food containing a high protein, low carbohydrate cream.
